(19) United States
(12) Patent Application Publication
(10) Pub. No.: US 2021/0090361 A1
(43) Pub. Date: Mar. 25, 2021

(54) METHOD AND SYSTEM FOR ENABLING PREVENTIVE MAINTENANCE AND SECURITY FOR VEHICLES IN LONG HAUL ENVIRONMENT

(71) Applicant: Camions Logistics Solutions Private Limited, New Delhi (IN)

(72) Inventors: Sumit SHARMA, North West Delhi (IN); Parag AGGARWAL, North East Delhi (IN); Naitik BAGHLA, Faridkot (IN)

(73) Assignee: Camions Logistics Solutions Private Limited, New Delhi (IN)

(21) Appl. No.: 16/810,743

(22) Filed: Mar. 5, 2020

(30) Foreign Application Priority Data
Sep. 19, 2019 (IN) 201911037809

(51) Int. Cl. G07C 5/08; G06Q 10/00; G05D 1/02; G07C 5/00

(52) U.S. Cl. CPC G07C 5/0841; G07C 5/006; G05D 1/0297; G06Q 10/20

(57) ABSTRACT

The present disclosure provides a method, non-transitory computer-readable storage medium, and a vehicle tracking system for enabling preventive maintenance and security for vehicles in long haul environment. The vehicle tracking system receives a historical data, a current status data and an administrator specified data. In addition, the vehicle tracking system analyzes the historical data, the current status data and the administrator specified data. Further, the vehicle tracking system determines an optimized route for a plurality of vehicles. Furthermore, the vehicle tracking system sends an alert to an administrator if any of the plurality of vehicles deviates from the optimized route. Moreover, the vehicle tracking system alerts the administrator for a preventive maintenance.

### TECHNICAL FIELD

The present disclosure relates to the field of logistics, and in particular, relates to a method and system for enabling preventive maintenance and security for vehicles in long haul environment.

### INTRODUCTION

With the advent in technological advancements over the past few decades, there has been an exponential rise in the logistics industry. Efficient transportation systems are highly valuable for security, lowering expenses and maintenance. Numerous methods and devices have been developed for efficiently managing and tracking of transportation vehicles involved in transportation of goods. The transportation vehicles generally follow a pre-defined route as per a route map provided by existing navigation systems. In addition, the pre-defined route may or may not be an optimized route for particular source and destination. The transportation vehicles may deviate from an optimized or pre-defined route. In addition, the deviation may affect the transportation cost severely. Further, tracking of deviations from the optimized or pre-defined route is essential for cost optimization and security purposes.

### SUMMARY

In a first example, a computer-implemented method is provided. The computer-implemented method is configured to enable preventive maintenance and security for vehicles in long haul environment. The computer-implemented method includes a first step to fetch a historical data from one or more databases. The historical data is associated with past journeys of a plurality of vehicles. In addition, the historical data is fetched in real time. In addition the computer-implemented method includes a second step to receive a current status data from one or more tracking devices. The current status data is associated with the plurality of vehicles. In addition, the current status data is received in real time. Further, the computer-implemented method includes a third step to obtain an administrator specified data from one or more media devices. In addition, the administrator specified data is modified by the administrator in real time. Further, the administrator specified data is obtained in real time. Furthermore, the computer-implemented method includes a fourth step to analyze the historical data, the current status data and the administrator specified data. In addition, analysis is done using one or more machine learning algorithms. Further, the historical data, the current status data and the administrator specified data are analyzed in real time. Moreover, the computer-implemented method includes a fifth step to determine an optimized route for the plurality of vehicles. The optimized route determination is based on the analysis of the historical data. In addition, the optimized route is determined in real time. Also, the computer-implemented method includes a sixth step to send an alert to administrator. The alert is sent to the administrator if any of the plurality of vehicles exceeds a deviation threshold set by the administrator. In addition, the alert is sent to the administrator for each deviation from the optimized route that exceeds the deviation threshold. Further, the deviation threshold is modified by the administrator in real time. Furthermore, the alert is sent to the administrator in real time. In addition, the computer-implemented method includes a seventh step of alerting the administrator for a preventive maintenance of the plurality of vehicles. The administrator is alerted once any of the plurality of vehicles exceeds a distance threshold set by the administrator. In addition, the distance threshold is modified by the administrator in real time. Further, the administrator is alerted in real time.

In an embodiment of the present disclosure, the historical data includes past routes, fuel consumption, time taken, road condition, past traffic patterns, number of stops, number of kilometers, average speed, average cost per kilometer, security arrangement, number of tolls and the like.

In an embodiment of the present disclosure, the current status data includes current speed, number of kilometers, current location, number of stops taken, traffic condition, security arrangements, number of tolls crossed and the like.

In an embodiment of the present disclosure, the current status data is received from the one or more tracking devices. The one or more tracking devices are installed in the plurality of vehicles. In addition, the one or more tracking devices includes wireless passive tracking system, cellular tracking system, satellite tracking system, telematics system, Global navigation satellite system, Global positioning system and the like.

In an embodiment of the present disclosure, the administrator specified data comprises the deviation threshold, the distance threshold, maximum speed limit, stops limit, average cost limit, total time limit and the like.

In an embodiment of the present disclosure, determination of the optimized route is based on comparison of various routes based on fuel consumption, time taken, security arrangement, average speed, number of kilometers. In addition, comparison is done in real time.

In an embodiment of the present disclosure, the alert is sent to the administrator after comparing each deviation of the plurality of vehicles from the optimized route with the deviation threshold set by the administrator. In addition, comparison is done in real time.

In an embodiment of the present disclosure, the administrator is alerted after comparing total distance travelled by the plurality of vehicles with the distance threshold set by the administrator. In addition, the administrator is alerted for the preventive maintenance of the plurality of vehicles.

In an embodiment of the present disclosure, the vehicle tracking system grabs current location of the plurality of vehicles through telecommunication channels. In addition, current location of the plurality of vehicles is grabbed at a fixed interval of time. Further, current location of the plurality of vehicles is grabbed in real time.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for enabling preventive maintenance and security for vehicles in long haul environment. The method includes a first step to fetch a historical data from one or more databases. The historical data is associated with past journeys of a plurality of vehicles. In addition, the historical data is fetched in real time. In addition the method includes a second step to receive a current status data from one or more tracking devices. The current status data is associated with the plurality of vehicles. In addition, the current status data is received in real time. Further, the method includes a third step to obtain an administrator specified data from one or more media devices. In addition, the administrator specified data is modified by the administrator in real time. Further, the administrator specified data is obtained in real time. Furthermore, the method includes a fourth step to analyze the historical data, the current status data and the administrator specified data. In addition, analysis is done using one or more machine learning algorithms. Further, the historical data, the current status data and the administrator specified data are analyzed in real time. Moreover, the method includes a fifth step to determine an optimized route for the plurality of vehicles. The optimized route determination is based on the analysis of the historical data. In addition, the optimized route is determined in real time. Also, the method includes a sixth step to send an alert to administrator. The alert is sent to the administrator if any of the plurality of vehicles exceeds a deviation threshold set by the administrator. In addition, the alert is sent to the administrator for each deviation from the optimized route that exceeds the deviation threshold. Further, the deviation threshold is modified by the administrator in real time. Furthermore, the alert is sent to the administrator in real time. In addition, the method includes a seventh step of alerting the administrator for a preventive maintenance of the plurality of vehicles. The administrator is alerted once any of the plurality of vehicles exceeds a distance threshold set by the administrator. In addition, the distance threshold is modified by the administrator in real time. Further, the administrator is alerted in real time.

In a third example, a non-transitory computer-readable storage medium is provided. The non-transitory computer-readable storage medium encodes computer executable instructions that, when executed by at least one processor, performs a method. The method is configured to enable preventive maintenance and security for vehicles in long haul environment. The method includes a first step to fetch a historical data from one or more databases. The historical data is associated with past journeys of a plurality of vehicles. In addition, the historical data is fetched in real time. In addition the method includes a second step to receive a current status data from one or more tracking devices. The current status data is associated with the plurality of vehicles. In addition, the current status data is received in real time. Further, the method includes a third step to obtain an administrator specified data from one or more media devices. In addition, the administrator specified data is modified by the administrator in real time. Further, the administrator specified data is obtained in real time. Furthermore, the method includes a fourth step to analyze the historical data, the current status data and the administrator specified data. In addition, analysis is done using one or more machine learning algorithms. Further, the historical data, the current status data and the administrator specified data are analyzed in real time. Moreover, the method includes a fifth step to determine an optimized route for the plurality of vehicles. The optimized route determination is based on the analysis of the historical data. In addition, the optimized route is determined in real time. Also, the method includes a sixth step to send an alert to administrator. The alert is sent to the administrator if any of the plurality of vehicles exceeds a deviation threshold set by the administrator. In addition, the alert is sent to the administrator for each deviation from the optimized route that exceeds the deviation threshold. Further, the deviation threshold is modified by the administrator in real time. Furthermore, the alert is sent to the administrator in real time. In addition, the method includes a seventh step of alerting the administrator for a preventive maintenance of the plurality of vehicles. The administrator is alerted once any of the plurality of vehicles exceeds a distance threshold set by the administrator. In addition, the distance threshold is modified by the administrator in real time. Further, the administrator is alerted in real time.

### BRIEF DESCRIPTION OF DRAWINGS

Having thus described the invention in general terms, references will now be made to the accompanying figures, wherein:

FIG. 1 illustrates an interactive computing environment for enabling preventive maintenance and security for vehicles in long haul environment, in accordance with various embodiments of the present disclosure;

FIGS. 2A and 2B illustrate a flow chart of a method for enabling the preventive maintenance and security for the vehicles in long haul environment, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

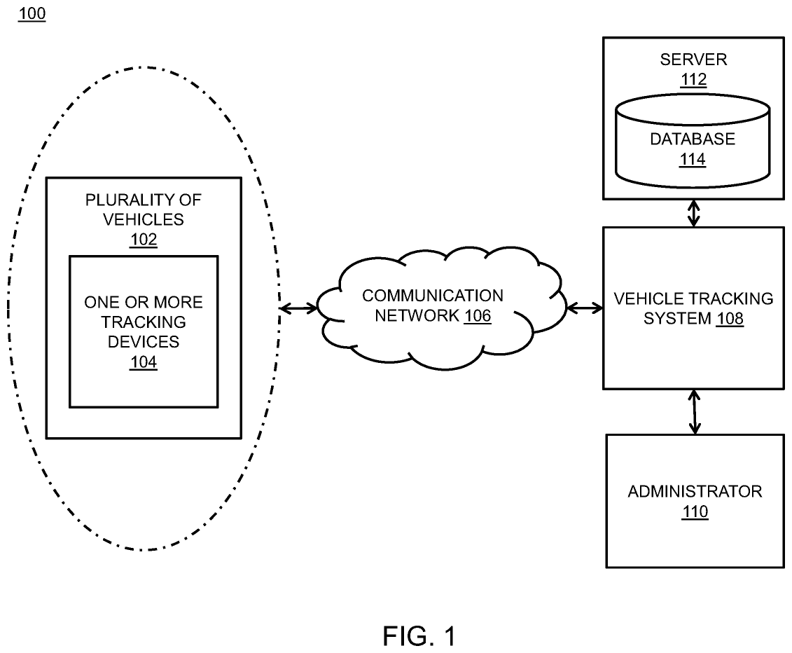

FIG. 1 illustrates an interactive computing environment 100 for enabling preventive maintenance and security for vehicles in long haul environment, in accordance with various embodiments of the present disclosure. The interactive computing environment 100 shows a relationship between various entities involved in enabling preventive maintenance and security for vehicles in long haul environment. The interactive computing environment 100 includes a plurality of vehicles 102, one or more tracking devices 104, a communication network 106, a vehicle tracking system 108, an administrator 110, a server 112 and a database 114. Each of the components of the interactive computing environment 100 interacts with each other for enabling preventive maintenance and security for vehicles in long haul environment

The interactive computing environment 100 includes the plurality of vehicles 102. In an embodiment of the present disclosure, each of the plurality of vehicles 102 is a commercial transportation vehicle. In another embodiment of the present disclosure, each of the plurality of vehicles 102 is a public transportation vehicle. In yet another embodiment of the present disclosure, the plurality of vehicles 102 is a private vehicle. In addition, the plurality of vehicles 102 is used for carrying goods from a point of origin to a point of destination. In an embodiment of the present disclosure, the plurality of vehicles 102 contains goods and items which are to be delivered from the point of origin to a point of consumption. In another embodiment of the present disclosure, the plurality of vehicles 102 is used for carrying unit loads with facilitation of pulls freight container such as intermodal container, swap bodies, semi-trailer and the like. In yet another embodiment of the present disclosure, the plurality of vehicles 102 performs a physical process of transporting commodities, merchandise goods, cargo and the like. In an embodiment of the present disclosure, the plurality of vehicles 102 includes pickup trucks, box trucks, semi-trucks, vans, coaches, buses, taxicabs, trailers, travel trailers and the like.

Furthermore, the interactive computing environment 100 includes the one or more tracking devices 104. The one or more tracking devices 104 are installed in the plurality of vehicles 102. The one or more tracking devices 104 associated with each of the plurality of vehicles 102 is integrated with the vehicle tracking system 108 for enabling real time unified tracking of the vehicles. In an embodiment of the present disclosure, the one or more tracking devices 104 includes but may not be limited to wireless passive tracking system, cellular tracking system, satellite tracking system, telematics system, Global navigation satellite system, Global positioning system. In an embodiment of the present disclosure, the one or more tracking device is Global positioning system. In another embodiment of the present disclosure, the one or more tracking devices 104 are associated with a global navigation satellite system. In yet another embodiment of the present disclosure, the one or more tracking devices 104 are associated with a cellular tracking system. In addition, the one or more tracking devices 104 send a current status data to the vehicle tracking system 108 through the communication network 106. In an embodiment of the present disclosure, the current status data includes but may not be limited to current speed, number of kilometers, current location, number of stops taken, traffic condition, security arrangements and number of tolls crossed. In an embodiment of the present disclosure, the plurality of vehicles 102 may or may not be equipped with the one or more tracking devices 104.

Furthermore, the interactive computing environment 100 includes the communication network 106 as shown in FIG. 1. In an embodiment of the present disclosure, the communication network 106 enables communication device to gain access to internet. In addition, internet connection is established based on a type of network. In an embodiment of the present disclosure, the type of network is a wireless mobile network. In another embodiment of the present disclosure, the type of network is a wired network with a finite bandwidth. In yet another embodiment of the present disclosure, the type of network is a combination of the wireless and the wired network for an optimum throughput of data transmission. Further, the communication network 106 includes set of channels. In addition, each channel of set of channels supports finite bandwidth. Further, finite bandwidth of each channel of the set of channels is based on capacity of network.

In addition, the communication network 106 provides medium for sharing information between media devices and the vehicle tracking system 108. In addition, media devices are associated with the vehicle tracking system 108. In addition, media device is associated with the vehicle tracking system 108 through the communication network 106.

Further, the medium for communication may be infrared, microwave, radio frequency (RF) and the like. The communication network 106 include but may not be limited to a local area network, a metropolitan area network, a wide area network, a virtual private network, a global area network, a home area network or any other communication network presently known in the art. The communication network 106 is a structure of various nodes or communication devices connected to each other through network topology method. Examples of the network topology include a bus topology, a star topology, a mesh topology and the like.

Moreover, the interactive computing environment 100 includes the administrator 110. The vehicle tracking system 108 is associated with the administrator 110. In addition, the administrator 110 is any person or individual who monitors working of the vehicle tracking system 108 in real time. In an embodiment of the present disclosure, the administrator 110 monitors working of the vehicle tracking system 108 through a portable communication device. In an embodiment of the present disclosure, the portable communication device includes but may not be limited to a laptop, a desktop computer, a tablet, a personal digital assistant and the like.

Further, the administrator 110 sends an administrator specified data to the vehicle tracking system 108 through one or more media devices. The administrator specified data is modified by the administrator 110 in real time. In an embodiment of the present disclosure, the administrator specified data includes but may not be limited to a deviation threshold, a distance threshold, maximum speed limit, stops limit, average cost limit and total time limit.

Also, the interactive computing environment 100 includes the vehicle tracking system 108 as shown in FIG. 1. The vehicle tracking system 108 performs various operations for enabling preventive maintenance and security for vehicles in long haul environment. In an embodiment of the present disclosure, the vehicle tracking system 108 is interconnected with the plurality of vehicles 102 through the communication network 106. The vehicle tracking system 108 fetches a historical data associated with past journeys of the plurality of vehicles 102 from one or more databases in real time. In an embodiment of the present disclosure, the historical data associated with the past journeys of the plurality of vehicle 102 includes but may not be limited to past routes, fuel consumption, time taken, road condition, past traffic patterns, number of stops, number of kilometers, average speed, average cost per kilometer, security arrangement and number of tolls. Further, the vehicle tracking system 108 receives the current status data from the one or more tracking devices 104 installed in the plurality of vehicles 102.

In an embodiment of the present disclosure, the plurality of vehicles 102 may or may not be equipped with the one or more tracking devices 104. In addition, the vehicle tracking system 108 utilizes cellular tracking technology for tracking the plurality of vehicles 102 that are not equipped with the one or more tracking devices 104. The vehicle tracking system 108 grabs the current location of each of the plurality of vehicles 102 that are not equipped with the one or more tracking devices 104 through telecommunication channels. In an embodiment of the present disclosure, the vehicle tracking system 108 grabs the current location of each of the plurality of vehicles 102 by tracking International Mobile Equipment Identity of cellphone of driver of each of the plurality of vehicles 102. In addition, the vehicle tracking system 108 grabs the current location of the plurality of vehicles 102 at fixed interval of time. Further, the current location of the plurality of vehicles 102 is grabbed in real time. In an embodiment of the present disclosure, the vehicle tracking system 108 enables manual grabbing of the location of the plurality of vehicles 102 through a grab icon which is placed on the vehicle icon visible in map and accordingly grabbing the location of the vehicles.

Further, the vehicle tracking system 108 obtains the administrator specified data from one or more media devices in real time. The administrator specified data is associated with current journey of the plurality of vehicles 102. Furthermore, the vehicle tracking system 108 analyzes the historical data, the current status data and the administrator specified data in real time. In addition, analysis is done using one or more machine learning algorithms. In an embodiment of the present disclosure, the one or more machine learning algorithms include but may not be limited to linear regression, logistic regression, decision tree, sum of vector machine, naïve Bayes, k nearest neighbour, random forest, time series, k-means. In general, machine learning algorithms are used to develop different models for datasets. In addition, datasets are divided into training dataset and test dataset. Further, training dataset is used to train the model that is developed using the machine learning algorithm. Furthermore, test dataset is used to test the efficiency and accuracy of the developed model.

Moreover, the vehicle tracking system 108 determines an optimized route for the plurality of vehicles 102. The optimized route is determined based on analysis of the historical data associated with past journeys of the plurality of vehicles 102. The vehicle tracking system 108 determines all routes taken by the plurality of vehicles 102 in the past for particular source and destination. In addition, the optimized route is determined by comparing various routes taken by the plurality of vehicles 102 in the past. Further, comparison of various routes are done based on fuel consumption, time taken, security arrangement, average speed, number of kilometers. The comparison is done in real time. Furthermore, the vehicle tracking system 108 recognizes the optimized route taken by the plurality vehicles 102 which travelled in the past for particular source and destination to determine actual distance travelled by the plurality of vehicles 102. Moreover, the vehicle tracking system 108 identifies and provides the optimized route to the plurality of vehicles 102 through the communication network 106.

In an example, a truck is scheduled for transporting goods from source X to destination Y. The vehicle tracking system 108 fetches the historical data of all past journeys of the plurality of vehicles 102 from source X to destination Y. In addition, the vehicle tracking system 108 determines all routes taken by the plurality of vehicles 102 in the past from source X to destination Y. In addition, the vehicle tracking system 108 recognizes the optimized route Z of the plurality vehicles 102 which travelled from source X to destination Y in the past. Further, the vehicle tracking system 108 analyzes the historical data and compares various routes on the basis of time take, fuel consumption, total distance, cost per kilometer and the like. Furthermore, the vehicle tracking system 108 determines the optimized route Z for the truck to travel from source X to destination Y.

Also, the vehicle tracking system 108 sends an alert to the administrator 110 if any of the plurality of vehicles 102 exceeds the deviation threshold set by the administrator 110. The deviation corresponds to a deviation from an actual route that each of the plurality of vehicles 102 are supposed to be travelling on. The deviation threshold corresponds to a maximum threshold from the actual route allowed for each of the plurality of vehicles 102. The administrator 110 provides an input to the vehicle tracking system 108 in real time through the web based platform for setting the deviation threshold for the plurality of vehicles 102 for security purposes. In addition, the vehicle tracking system 108 records deviation each time and checks whether the plurality of vehicles 102 deviates more than the deviation threshold.

Further, the alert is sent to the administrator 110 for each deviation of the plurality of vehicles 102 from the optimized route that exceeds the deviation threshold. The vehicle tracking system 108 sends the alert to the administrator on a web based platform associated with the vehicle tracking system 108. The web based platform enables real time visualization for tracking of the plurality of vehicles 102. In addition, the web based platform enables real time visualization of deviation from the optimized route. Further, the deviation threshold is modified by the administrator 110 as per the requirement in real time. In an embodiment of the present disclosure, the deviation threshold is optimized differently for each of the plurality of vehicles 102.

In continuation of the above stated example, the vehicle tracking system 108 receives the current status data associated with the truck through the one or more tracking devices 104. In addition, the vehicle tracking system 108 obtains the administrator specified data from the administrator 110 through the web based platform. Further, the administrator 110 specifies the deviation threshold of 500 meter radius from the optimized route Z. Furthermore, the vehicle tracking system 108 records each deviation of the truck from the optimized route Z. Moreover, the vehicle tracking system 108 checks whether the truck deviates more than 500 meter radius from the optimized route. Moreover, the vehicle tracking system 108 sends the alert to the administrator 110 on the web based platform if the truck exceeds the deviation threshold of 500 meter radius. Also, the deviation threshold of 500 meter radius is modified by the administrator 110 in real time. Also, deviation of the plurality of vehicles is calculated using the current location of the truck grabbed by the vehicle tracking system 108.

In addition, the vehicle tracking system 108 alerts the administrator 110 for the preventive maintenance of the plurality of vehicles 102. The vehicle tracking system 108 counts total distance travelled by each of the plurality of vehicles 102. In addition, the vehicle tracking system 108 alerts the administrator 110 if any of the plurality of vehicles 102 exceeds the distance threshold set by the administrator 110. Further, the administrator 110 is alerted for the preventive maintenance of each of the plurality of vehicles 102 that exceeds the distance threshold set by the administrator 110. Furthermore, the distance threshold is modified in real time as per requirement through the web based platform.

In continuation of the above stated example, the vehicle tracking system 108 counts total distance covered by the truck. In addition, the administrator 110 specifies the distance threshold of 500 kilometers. Further, the vehicle tracking system 108 continuously compares total distance travelled by the truck and the distance threshold of 500 kilometers. Furthermore, the vehicle tracking system 108 alerts the administrator 110 if total distance travelled by the truck exceeds the distance threshold of 500 kilometers. Moreover, the administrator 110 is alerted for the preventive maintenance of the truck. Also, the administrator 110 can modify the distance threshold for the truck as per the requirement.

In addition, the interactive computing environment 100 includes the database 114 as shown in FIG. 1. The database 114 is where all the information is stored for accessing. The database 114 includes data which is pre-stored in the database 114 and data collected in real-time. The database 114 may be a cloud database or any other database based on the requirement for real time assignment of the plurality of servicemen in event of fault detection. The data is stored in the database 114 in various tables. The tables are matrix that store different type of data in the form rows and columns. In an example, one table may store the historical data associated with the plurality of vehicles 102 and in other table the current status data associated with the plurality of vehicles 102 is stored. The database 114 is included inside the server 112.

Further, the interactive computing environment includes the server 112. The server 112 is used to perform task of accepting request and respond to the request of other functions. The server 112 may be a cloud server which is used for cloud computing to enhance the real time processing of the system and using virtual space for task performance. In an embodiment of the present disclosure, the server 112 may be any other server based on the requirement for enabling preventive maintenance and security for vehicles in long haul environment.

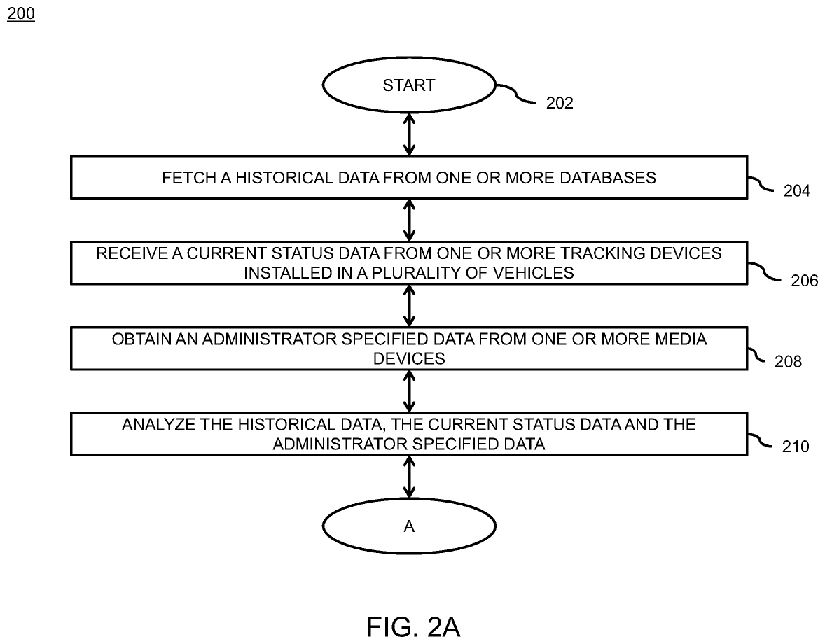

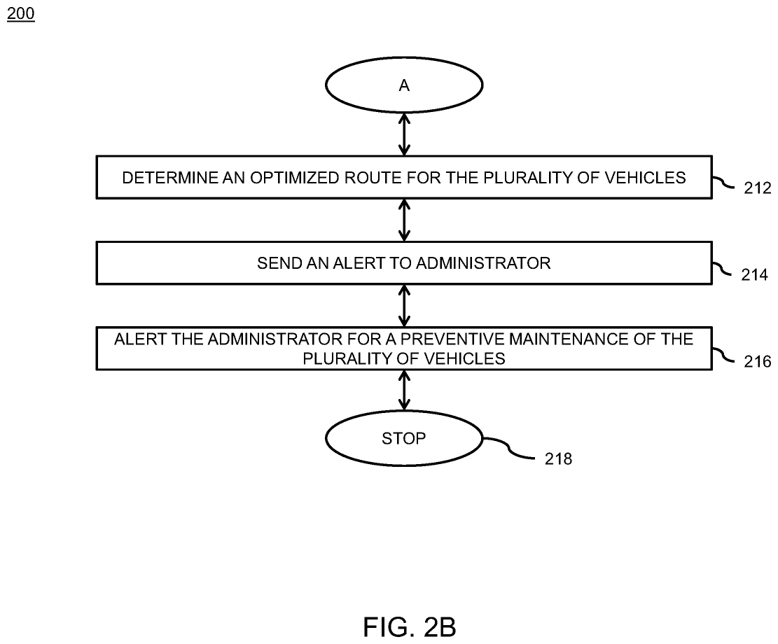

FIGS. 2A and 2B illustrate a flow chart of a method for enabling preventive maintenance and security for vehicles in long haul environment, in accordance with various embodiments of the present disclosure. It may be noted that to explain the process steps of flowchart 200, references will be made to the system elements of FIG. 1. It may also be noted that the flowchart 200 may have lesser or more number of steps.

The flow chart 200 initiates at step 202. Following step 202, at step 204, the vehicle tracking system 108 fetches the historical data from the one or more databases. The historical data is associated with the past journeys of the plurality of vehicles 102. Following step 204, at step 206, the vehicle tracking system 108 receives the current status data from the one or more tracking devices 104. The current status data is associated with the plurality of vehicles 102. Following step 206, at step 208, the vehicle tracking system 108 obtains the administrator specified data from the one or more media devices. In addition, the administrator specified data is modified by the administrator 110 in real time. Following step 208, at step 210, the vehicle tracking system 108 analyzes the historical data, the current status data and the administrator specified data. In addition, the analysis is done using the one or more machine learning algorithms. Further, the historical data, the current status data and the administrator specified data are analyzed in real time. Following step 210, at step 212, the vehicle tracking system 108 determines the optimized route for the plurality of vehicles 102. The optimized route determination is based on the analysis of the historical data. In addition, the optimized route is determined in real time. Following step 212, at step 214, the vehicle tracking system 108 sends the alert to the administrator 110. The alert is sent to the administrator 110 if any of the plurality of vehicles 102 exceeds the deviation threshold set by the administrator 110. In addition, the alert is sent to the administrator 110 for each deviation from the optimized route that exceeds the deviation threshold. Further, the deviation threshold is modified by the administrator 110 in real time. Furthermore, the alert is sent to the administrator 110 in real time. Following step 214, at step 216, the vehicle tracking system 108 alerts the administrator for the preventive maintenance of the plurality of vehicles. The administrator is alerted once any of the plurality of vehicles 102 exceeds the distance threshold set by the administrator 110. In addition, the distance threshold is modified by the administrator 110 in real time. Further, the administrator 110 is alerted in real time.

The flow chart 200 terminates at step 218. It may be noted that the flowchart 200 is explained to have above stated process steps; however, those skilled in the art would appreciate that the flowchart 200 may have more/less number of process steps which may enable all the above stated embodiments of the present disclosure.

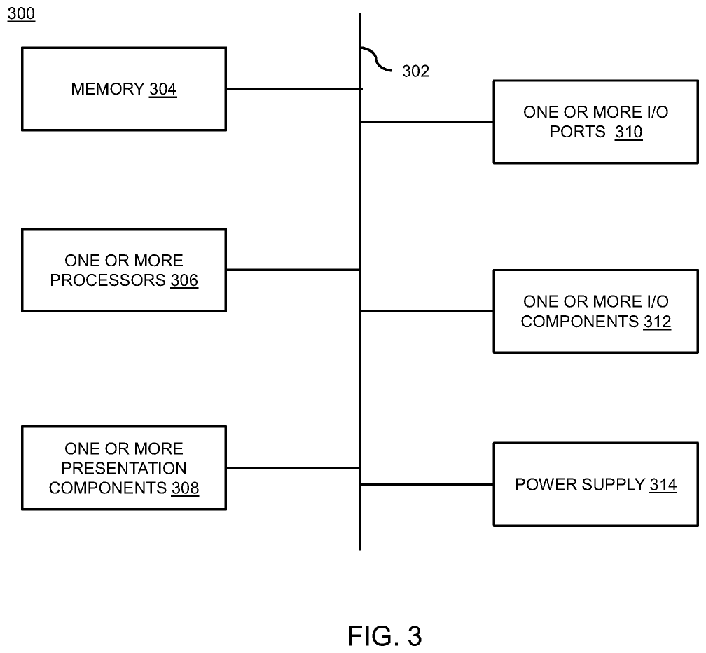

FIG. 3 illustrates a block diagram of a computing device 300, in accordance with various embodiments of the present disclosure. In an embodiment of the present disclosure, the computing device 300 illustrates hardware elements of each communication device of the communication devices 104. The computing device 300 is a non-transitory computer readable storage medium. The computing device 300 includes a bus 302 that directly or indirectly couples the following devices: memory 304, one or more processors 206, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any system or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for enabling preventive maintenance and security for vehicles in long haul environment, the computer-implemented method comprising:
fetching, at a vehicle tracking system with a processor, a historical data from one or more databases, wherein the historical data is associated with past journeys of a plurality of vehicles, wherein the historical data is fetched in real time;
receiving, at the vehicle tracking system with the processor, a current status data from one or more tracking devices installed in the plurality of vehicles, wherein the current status data is associated with the plurality of vehicles, wherein the current status data is received in real time;
obtaining, at the vehicle tracking system with the processor, an administrator specified data from one or more media devices, wherein the administrator specified data is modified by an administrator in real time, wherein the administrator specified data is obtained in real time;
analyzing, at the vehicle tracking system with the processor, the historical data, the current status data and the administrator specified data, wherein the analysis is done using one or more machine learning algorithms, wherein the historical data, the current status data and the administrator specified data are analyzed in real time;
determining, at the vehicle tracking system with the processor, an optimized route for the plurality of vehicles, wherein the optimized route is determined based on the analysis of the historical data, wherein the optimized route is determined in real time;
sending, at the vehicle tracking system with the processor, an alert to the administrator, wherein the alert is sent to the administrator if any of the plurality of vehicles exceeds a deviation threshold set by the administrator, wherein the alert is sent to the administrator for each deviation from the optimized route that exceeds the deviation threshold, wherein the deviation threshold is modified by the administrator in real time, wherein the alert is sent to the administrator in real time; and
alerting, at the vehicle tracking system with the processor, the administrator for a preventive maintenance of the plurality of vehicles, wherein the administrator is alerted if any of the plurality of vehicles exceeds a distance threshold set by the administrator, wherein the distance threshold is modified by the administrator in real time, wherein the administrator is alerted in real time.

2. The computer-implemented method as recited in claim 1, wherein the historical data comprises past routes, fuel consumption, time taken, road condition, past traffic patterns, number of stops, number of kilometers, average speed, average cost per kilometer, security arrangement and number of tolls.

3. The computer-implemented method as recited in claim 1, wherein the current status data comprises current speed, number of kilometers, current location, number of stops taken, traffic condition, security arrangements and number of tolls crossed.

4. The computer-implemented method as recited in claim 1, wherein the current status data is received from the one or more tracking devices, wherein the one or more tracking devices are installed in the plurality of vehicles, wherein the one or more tracking devices comprising wireless passive tracking system, cellular tracking system, satellite tracking system, telematics system, Global navigation satellite system and Global positioning system.

5. The computer-implemented method as recited in claim 1, wherein the administrator specified data comprising the deviation threshold, the distance threshold, maximum speed limit, stops limit, average cost limit and total time limit.

6. The computer-implemented method as recited in claim 1, wherein the optimized route is determined based on comparison of various routes taken by the plurality of vehicles in the past, wherein the comparison is based on fuel consumption, time taken, security arrangement, average speed, number of kilometers, wherein comparison is done in real time.

7. The computer-implemented method as recited in claim 1, wherein the alert is sent to the administrator after comparing each deviation of the plurality of vehicles from the optimized route with the deviation threshold set by the administrator, wherein comparison is done in real time.

8. The computer-implemented method as recited in claim 1, wherein the administrator is alerted after comparing total distance travelled by the plurality of vehicles with the distance threshold set by the administrator, wherein the administrator is alerted for the preventive maintenance of the plurality of vehicles.

9. The computer-implemented method as recited in claim 1, further comprising grabbing, at the vehicle tracking system with the processor, current location of the plurality of vehicles through telecommunication channels, wherein current location of the plurality of vehicles is grabbed at a fixed interval of time, wherein current location of the plurality of vehicles is grabbed in real time.

10. A computer system comprising:
one or more processors; and
a memory coupled to the one or more processors, the memory for storing instructions which, when executed by the one or more processors, cause the one or more processors to perform a method for enabling preventive maintenance and security for vehicles in long haul environment, the method comprising:
fetching, at a vehicle tracking system, a historical data from one or more databases, wherein the historical data is associated with past journeys of a plurality of vehicles, wherein the historical data is fetched in real time;
receiving, at the vehicle tracking system, a current status data from one or more tracking devices installed in the plurality of vehicles, wherein the current status data is associated with the plurality of vehicles, wherein the current status data is received in real time;
obtaining, at the vehicle tracking system, an administrator specified data from one or more media devices, wherein the administrator specified data is modified by an administrator in real time, wherein the administrator specified data is obtained in real time;
analyzing, at the vehicle tracking system, the historical data, the current status data and the administrator specified data, wherein the analysis is done using one or more machine learning algorithms, wherein the historical data, the current status data and the administrator specified data are analyzed in real time;
determining, at the vehicle tracking system, an optimized route for the plurality of vehicles, wherein the optimized route is determined based on the analysis of the historical data, wherein the optimized route is determined in real time;
sending, at the vehicle tracking system, an alert to the administrator, wherein the alert is sent to the administrator if any of the plurality of vehicles exceeds a deviation threshold set by the administrator, wherein the alert is sent to the administrator for each deviation from the optimized route that exceeds the deviation threshold, wherein the deviation threshold is modified by the administrator in real time, wherein the alert is sent to the administrator in real time; and
alerting, at the vehicle tracking system, the administrator for a preventive maintenance of the plurality of vehicles, wherein the administrator is alerted if any of the plurality of vehicles exceeds a distance threshold set by the administrator, wherein the distance threshold is modified by the administrator in real time, wherein the administrator is alerted in real time.

11. The computer system as recited in claim 10, wherein the historical data comprising past routes, fuel consumption, time taken, road condition, past traffic patterns, number of stops, number of kilometers, average speed, average cost per kilometer, security arrangement and number of tolls.

12. The computer system as recited in claim 10, wherein the current status data comprising current speed, number of kilometers, current location, number of stops taken, traffic condition, security arrangements and number of tolls crossed.

13. The computer system as recited in claim 10, wherein the current status data is received from the one or more tracking devices, wherein the one or more tracking devices are installed in the plurality of vehicles, wherein the one or more tracking devices comprising wireless passive tracking system, cellular tracking system, satellite tracking system, telematics system, Global navigation satellite system and Global positioning system.

14. The computer system as recited in claim 10, wherein the administrator specified data comprising the deviation threshold, the distance threshold, maximum speed limit, stops limit, average cost limit and total time limit.

15. The computer system as recited in claim 1, wherein the optimized route is determined based on comparison of various routes taken by the plurality of vehicles in the past, wherein the comparison is based on fuel consumption, time taken, security arrangement, average speed, number of kilometers, wherein comparison is done in real time.

16. The computer system as recited in claim 10, wherein the alert is sent to the administrator after comparing each deviation of the plurality of vehicles from the optimized route with the deviation threshold set by the administrator, wherein comparison is done in real time.

17. The computer system as recited in claim 10, wherein the administrator is alerted after comparing total distance travelled by the plurality of vehicles with the distance threshold set by the administrator, wherein the administrator is alerted for the preventive maintenance of the plurality of vehicles.

18. The computer system as recited in claim 10, further comprising grabbing, at the vehicle tracking system, current location of the plurality of vehicles through telecommunication channels, wherein current location of the plurality of vehicles is grabbed at a fixed interval of time, wherein current location of the plurality of vehicles is grabbed in real time.

19. A non-transitory computer-readable storage medium encoding computer executable instructions that, when executed by at least one processor, performs a method for enabling preventive maintenance and security for vehicles in long haul environment, the method comprising:
fetching, at a computing device, a historical data from one or more databases, wherein the historical data is associated with past journeys of a plurality of vehicles, wherein the historical data is fetched in real time;
receiving, at the computing device, a current status data from one or more tracking devices installed in the plurality of vehicles, wherein the current status data is associated with the plurality of vehicles, wherein the current status data is received in real time;
obtaining, at the computing device, an administrator specified data from one or more media devices, wherein the administrator specified data is modified by an administrator in real time, wherein the administrator specified data is obtained in real time;
analyzing, at the computing device, the historical data, the current status data and the administrator specified data, wherein the analysis is done using one or more machine learning algorithms, wherein the historical data, the current status data and the administrator specified data are analyzed in real time;
determining, at the computing device, an optimized route for the plurality of vehicles, wherein the optimized route is determined based on the analysis of the historical data, wherein the optimized route is determined in real time;
sending, at the computing device, an alert to the administrator, wherein the alert is sent to the administrator if any of the plurality of vehicles exceeds a deviation threshold set by the administrator, wherein the alert is sent to the administrator for each deviation from the optimized route that exceeds the deviation threshold, wherein the deviation threshold is modified by the administrator in real time, wherein the alert is sent to the administrator in real time; and
alerting, at the computing device, the administrator for a preventive maintenance of the plurality of vehicles, wherein the administrator is alerted if any of the plurality of vehicles exceeds a distance threshold set by the administrator, wherein the distance threshold is modified by the administrator in real time, wherein the administrator is alerted in real time.

20. The non-transitory computer-readable storage medium as recited in claim 19, wherein the historical data comprising past routes, fuel consumption, time taken, road condition, past traffic patterns, number of stops, number of kilometers, average speed, average cost per kilometer, security arrangement and number of tolls, wherein the current status data comprises current speed, number of kilometers, current location, number of stops taken, traffic condition, security arrangements and number of tolls crossed.
